(19) United States
(12) Patent Application Publication
(10) Pub. No.: US 2002/0002940 A1
(43) Pub. Date: Jan. 10, 2002

(54) Thermometer and associated methods

(76) Inventor: Randall A. Loy, Longwood, FL (US)

Correspondence Address: Allen, Dyer, Doppelt, Milbrath & Gilchrist, P.A., Suite 1401, 255 South Orange Avenue, P.O. Box 3791, Orlando, FL, 32802-3791, US

(21) Appl. No.: 09/842,310

(22) Filed: Apr. 25, 2001

Related U.S. Application Data
(60) Provisional application No. 60/199,430, filed on Apr. 25, 2000.

(51) Int. Cl. G01K 11/12; G01K 13/00

(52) U.S. Cl. 116/216; 374/156; 374/162; 116/207

(57) ABSTRACT

A thermometer includes an elongated strip-like member and an elongated enclosed tube affixed thereto. Either the strip or the tube has temperature-indicating indicia therealong. The tube contains a composition having expansion and contraction properties within a desired temperature range sufficient to enable a measurement of a temperature therewith, using the indicia having been calibrated with a known standard. Alternatively, the thermometer may include a temperature-measuring device that does not require a tube, such as a solid-state element. In a first embodiment the thermometer is floatable in a liquid, such as bath water. In a second embodiment the thermometer is affixable to a vessel, such as a baby bottle.

### CROSS-REFERENCE TO RELATED APPLICATION

This application claims priority from provisional application Serial No. 60/199,430, filed Apr. 25, 2000, entitled “Thermometer and Method.”

### BACKGROUND OF THE INVENTION

1. Field of the Invention

The present invention relates to thermometers and methods of making and using same, and, more particularly, to such devices and methods for providing a continuous measurement of the temperature of a liquid intended for contact with an infant or child.

2. Description of Related Art

Parents and care-givers can have difficulty judging whether the temperature of a liquid that is intended for contact with an infant or child is within a desired range and will not cause discomfort to or damage the infant. Such liquids may include, but are not intended to be limited to, bath water and drinking fluids.

Floating thermometers are known in the art (U.S. Pat. Nos. 3,961,531, 5,302,028, and D312,975). Thermometers for measuring liquids in vessels are also known in the art (U.S. Pat. Nos. 4,022,060, 4,878,588, 5,553,941, and 5,738,442).

### SUMMARY OF THE INVENTION

It is therefore an object of the present invention to provide a thermometer for measuring a temperature of a liquid intended for contact with an infant.

It is another object to provide such a thermometer having means for floating in a liquid.

It is a further object to provide such a thermometer having means for indicating a predetermined acceptable temperature range.

It is an additional object to provide such a thermometer having means for being affixed to a liquid-containing vessel.

These and other objects are achieved by the thermometer and method of the present invention, an elongated strip member and an elongated enclosed tube affixed thereatop. Preferably the tube length is less than the strip member length Either the strip or the tube has temperature-indicating indicia therealong.

The tube contains a temperature-sensitive composition having expansion and contraction properties within a desired temperature range sufficient to enable a measurement of a temperature therewith, using the indicia having been calibrated with a known standard.

In a first embodiment the thermometer further comprises means for floating the strip in a liquid.

In a second embodiment the thermometer further comprises means for being affixed to a vessel.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 illustrates a top plan view of a floating thermometer.

FIG. 2 illustrates a side view of a thermometer affixable to a vessel.

### DETAILED DESCRIPTION OF THE PREFERRED EMBODIMENTS

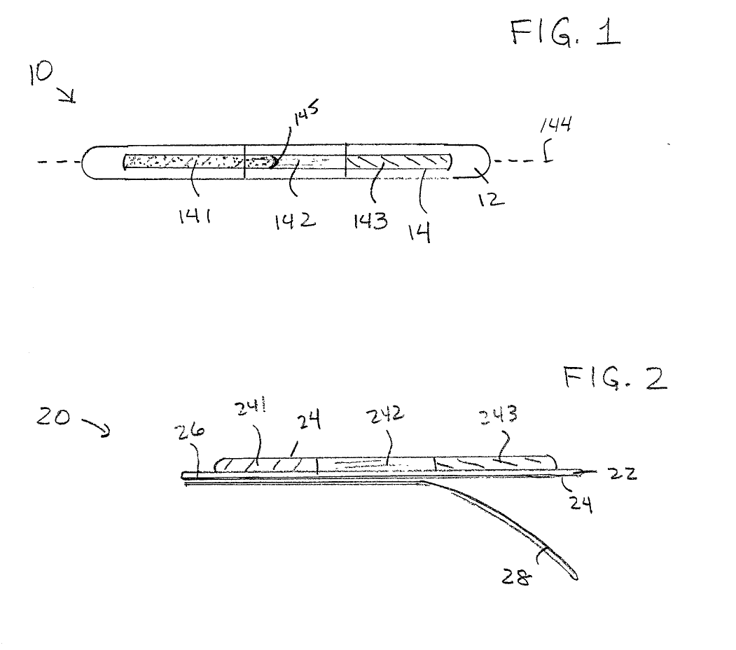

A description of the preferred embodiments of the present invention will now be presented with reference to FIGS. 1 and 2.

A first embodiment of the thermometer 10 of the present invention is adapted for floating in a liquid. Such an embodiment 10 may be used, for example, for measuring the temperature of bath water prior to placing an infant or child therein.

The thermometer 10 comprises an elongated strip-like member 12 and an elongated sealed tube 14 affixed thereto. Either the strip 12 or the tube 14 has temperature-indicating means such as indicia therealong. In this embodiment the tube 14 contains a composition having expansion and contraction properties within a desired temperature range sufficient to enable a measurement of a temperature therewith, using the indicia having been calibrated with a known standard. Alternatively, the thermometer may comprise another type of indicating means, such as a solid-state device with an LCD readout.

In a particular embodiment for use with bath water, the tube 14 is divided into three sections along a longitudinal axis 144 to enable a rapid and reliable indication of the state of the bath water relating to a likely thermal comfort level. If the temperature-indicating fluid's meniscus 145 lies within the first section 141, which may, for further ease, be colored or backed in a color such as blue, the water is too cold; if within the second section 142, neutral color, the water is in an acceptable range; if within the third section 143, which may be colored or backed in a color such as red, the water is too hot. In the case of an LCD readout, the “meniscus” may comprise an edge of a bar that moves in response to temperature changes.

In a second embodiment the thermometer 20 further comprises means for being affixed to a vessel. This embodiment 20 is contemplated for use, for example, for measuring the temperature of a drinking liquid in a bottle, such as warm milk. Here the strip 22 further comprises an adhesive 24 affixed to a rear side 26 of the strip 22 and a removable covering layer 28 applied to protect the adhesive 24 until application to a surface is desired.

As above, either the strip 22 or the temperature-indicating tube 24 has temperature-indicating means such as indicia therealong. In this embodiment the tube 24 contains a composition having expansion and contraction properties within a desired temperature range sufficient to enable a measurement of a temperature therewith, using the indicia having been calibrated with a known standard. Alternatively, the thermometer may comprise another type of indicating means, such as a solid-state device with an LCD readout.

In a particular embodiment for use with bath water, the tube 24 is divided into three sections to enable a rapid and reliable indication of the state of the drinking fluid. If the temperature-indicating fluid's meniscus lies within the first section 241, which may, for further ease, be colored or backed in a color such as blue, the water is too cold; if within the second section 242, the water is in an acceptable range; if within the third section 243, which may be colored or backed in a color such as red, the water is too hot.

It may be appreciated by one skilled in the art that additional embodiments may be contemplated, including alternative temperature-measuring compositions and methods.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful construction, and reasonable mechanical equivalents thererof obvious to those skilled in the art, are set forth in the appended claims.

What is claimed is:

1. A floating thermometer for providing a temperature of a liquid for contact with an infant or child, the thermometer comprising:
an elongated strip member;
an elongated sealed tube affixed atop the strip member and having a length less than a length of the strip member;
a temperature-sensitive composition capable of providing an indication of temperature in a desired range sealed within an inner space of the tube;
a plurality temperature indicators positioned on at least one of the tube or the strip member, the indicators positioned commensurate with a position of a meniscus of the temperature-sensitive composition; and
means for providing substantially horizontal flotation, a level of suspending fluid generally parallel to the strip member.

2. The thermometer recited in claim 1, wherein the indicators comprise a plurality of sections along a longitudinal axis of the thermometer, each section representing a likely thermal comfort level of a temperature range encompassed thereby.

3. The thermometer recited in claim 2, wherein the sections comprise three sectors representing a too-cold, a too-hot, and an acceptable range.

4. The thermometer recited in claim 3, wherein the three sections each further comprise verbiage representative of the comfort level.

5. The thermometer recited in claim 3, wherein the three sections each further comprise colors representative of the comfort level, with blue for too cold, a neutral color for acceptable, and red for too hot.

6. A floating thermometer for providing a temperature of a liquid for contact with an infant or child, the thermometer comprising:
an elongated strip member;
temperature sensor affixed to the strip member;
a solid-state readout in communication with the temperature sensor capable of providing an indication of temperature in a desired range; and
means for providing substantially horizontal flotation, a level of suspending fluid generally parallel to the strip member.

7. The thermometer recited in claim 6, wherein the readout comprises a liquid crystal display.

8. The thermometer recited in claim 6, wherein the readout comprises an elongated display divided into a plurality of sections along a longitudinal axis of the thermometer, each section representing a likely thermal comfort level of a temperature range encompassed thereby.

9. The thermometer recited in claim 8, wherein the sections comprise three sectors representing a too-cold, a too-hot, and an acceptable range.

10. The thermometer recited in claim 9, wherein the three sections each further comprise verbiage representative of the comfort level.

11. The thermometer recited in claim 9, wherein the three sections each further comprise colors representative of the comfort level, with blue for too cold, a neutral color for acceptable, and red for too hot.

12. A method for monitoring a temperature of a liquid for contact with an infant or child, the method comprising the steps of:
placing a floating thermometer in the liquid, the thermometer comprising:
an elongated strip member;
an elongated sealed tube affixed atop the strip member and having a length less than a length of the strip member;
a temperature-sensitive composition capable of providing an indication of temperature in a desired range sealed within an inner space of the tube;
a plurality temperature indicators positioned on at least one of the tube or the strip member, the indicators positioned commensurate with a position of a meniscus of the temperature-sensitive composition; and
means for providing substantially horizontal flotation, a level of suspending fluid generally parallel to the strip member; and
viewing the temperature indicator containing the meniscus to determine whether it is advisable to place a child or infant in contact with the liquid.
